(19) United States
(12) Patent Application Publication
(10) Pub. No.: US 2008/0097971 A1
(43) Pub. Date: Apr. 24, 2008

(54) Peer-to-peer based secondary key search method and system for cluster database

(75) Inventors: Chung-Min Chen, Taipei (TW); Shih-Hung Chuang, Taipei (TW); Shan-Hung Wu, Taoyuan (TW); I-Ching Liao, Xindian City (TW); Euthimios Panagos, Madison, NJ (US); Munir Cochinwala, Basking Ridge, NJ (US)

Correspondence Address: BACON & THOMAS, PLLC, 625 SLATERS LANE, FOURTH FLOOR, ALEXANDRIA, VA, 22314, US

(73) Assignees: Telcordia Applied Research Center Taiwan Company, Taipei City (TW); Industrial Technology Research Institute, Chutung (TW)

(21) Appl. No.: 11/881,967

(22) Filed: Jul. 30, 2007

Related U.S. Application Data
(60) Provisional application No. 60/852,424, filed on Oct. 18, 2006.

(51) Int. Cl. G06F 7/10; G06F 17/30

(52) U.S. Cl. 707/3; 707/E17.014

(57) ABSTRACT

A peer-to-peer based secondary key search method and system for cluster databases is disclosed. A cluster database has a plurality of storage nodes and each storage node is assigned with a node number and stores a plurality of records. A search term input means couples to the plurality of storage nodes for retrieving a record at a storage node. The search term input means calculates a first node number based on a hash function of a secondary key, queries the first storage node with the secondary key for retrieving a corresponding primary key, calculates a second node number based on a hash function of the primary key, and then queries the second storage node with the primary key for retrieving a corresponding record.

### CROSS-REFERENCE TO RELATED APPLICATIONS

This application claims the benefit of U.S. Provisional Patent Application No. 60/852,424, filed Oct. 18, 2006, which is hereby incorporated herein by reference in its entirety.

### BACKGROUND OF THE INVENTION

1. Field of the Invention

The present invention relates to the technical field of database searching and, more particularly, to a secondary key search method and system for cluster database.

2. Description of Related Art

Modern telecom services, such as pre-paid services and number portability, require high-throughput and low-latency response from the service database (e.g. the ISCP (Integrated Services Control Point) database). The service database processes the real-time requests such as subscriber record creation, update and look-up. All these operations require a search based on some user identity. The search can be done efficiently by hashing on a unique attribute designated as the “primary key” (e.g. SSN). However, more often the search may have to be based on other identities, such as phone number, birthday, name, etc., called secondary key. Most network service platforms (including ISCP) are moving to adopt the new database cluster architecture for the reason of better performance/cost scalability. A database cluster consists of multiple nodes (e.g. tightly-coupled blade server or a pool of networked PC/workstation servers) and partitions the subscriber records among the nodes. A hash function is usually applied to the primary key to determine on which node a record should be stored and can be located. Search on secondary keys on a database cluster is insufficient using current known schemes.

To cope with the requirement, there are three major database cluster products on the market: Apertio, MySQL Cluster, and ClustRa.

The technology of Apertio uses an LDAP-based B-tree indexing structure to partition and search for user record. To search for a record, the technology of Apertio must traverse down the tree based on the LDAP path and find out at which node the record is stored.

ClustRa was the first in-memory database cluster product available on the market. ClustRa uses hashing-based partition of database among the nodes in the cluster. However, it only uses primary key-based access and sequential scan of the table. There is no secondary key access method supported by ClustRa.

MySQL allows for partition of data among storage nodes by applying a hash function to a designated primary key. Like ClustRa, MySQL does not support secondary key access such that the query has to be broadcasted to and performed on all nodes.

To solve the aforementioned problem, there are two technologies that support secondary key-based search in database cluster: Replicated Secondary Key Index and Broadcasting Search.

In Replicated Secondary Key Index technology, an index D on the secondary key is created such that for a given secondary key value, the index can quickly return the storage node in which the search record is located. Formally, D is given as a mapping such that D(r.b)=I if and only if record r is stored on storage node Si. The index D can be implemented in a hash table or a tree-based structure (such as B-tree). Most importantly, this index must be replicated. When receiving a secondary key-based search request, the Replicated Secondary Key Index technology will look up the index for the storage node that actually stores the record. Then, it forwards the request to the target storage node to retrieve the matched record.

In Broadcasting Search technology, when receiving a secondary key-based search request, this request is broadcasted to all storage nodes. Each storage node then performs a local search on its own local table. If a matched record is found, the record is returned, otherwise a not-found message is returned.

The aforementioned technologies fail to completely solve the problem. They look up a record based on a given secondary key by broadcasting this request to all nodes in the cluster. Each node then looks up its own local data to see if there is any record that matches the key. In doing such, all nodes have to perform a local search, even though only one node will return positive. The total communication and computation overhead therefore is proportional to the number of nodes N in the cluster, namely O(N). Therefore, it is desirable to provide a peer-to-peer based secondary key search method and system for cluster database that eliminates the aforesaid drawbacks.

### SUMMARY OF THE INVENTION

An object of the invention is to provide a peer-to-peer based secondary key search method and system for cluster database, which can reduce the bandwidth among the storage nodes so as to accelerate the search speed.

Another object of the invention is to provide peer-to-peer based secondary key search method and system for cluster database, which can provide better cost balance among record insertion, secondary key-based search, and the supporting data structures.

In accordance with one aspect of the present invention, there is provided a peer-to-peer based secondary key search method for cluster database. The cluster database has a plurality of storage nodes and each storage node has a node number and stores a plurality of records. The method comprising the steps of: (A) calculating a first node number based on a hash function of the secondary key; (B) querying the first storage node with the secondary key for retrieving a corresponding primary key; (C) calculating a second node number based on a hash function of the primary key; and (D) retrieving the corresponding record from the second storage node with the primary key.

In accordance with another aspect of the present invention, there is provided a peer-to-peer based secondary key search system. The system comprises a plurality of storage nodes and a search term input means. Each storage node of the plurality of storage nodes has a node number and stores a plurality of records. The search term input means is coupled to the plurality of storage nodes for retrieving a record on a storage node. The search term input means calculates a first node number based on a hash function of the secondary key, queries a first storage node with the secondary key for retrieving a corresponding primary key, calculates a second node number based on a hash function of the primary key, and then retrieves the record from the second storage with the primary key

Other objects, advantages, and novel features of the invention will become more apparent from the following detailed description when taken in conjunction with the accompanying drawings.

### BRIEF DESCRIPTION OF THE DRAWINGS

FIG. 1 is a schematic view showing a table T in a cluster in accordance with the present invention.

FIG. 2 is a schematic view of a peer-to-peer based secondary key search system in accordance with the present invention.

FIG. 3 is a flowchart for inserting a record into the database cluster in accordance with the present invention.

FIG. 4 is a flowchart for performing a secondary key-based record search in accordance with the present invention.

FIG. 5 is a schematic view for performing a secondary key-based record search in accordance with the present invention.

FIG. 6 and FIG. 7 are schematic views for structural and operational difference between Replicated Secondary Key Index, Broadcasting Search, and the invention.

### DETAILED DESCRIPTION OF THE PREFERRED EMBODIMENT

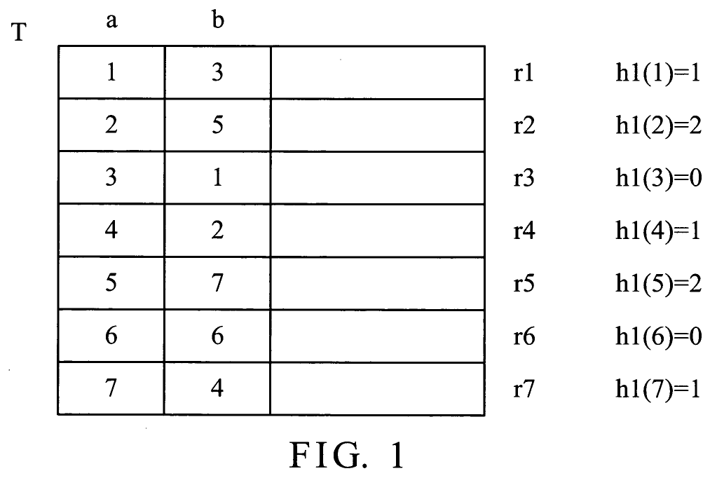

FIG. 1 is a schematic view showing a table T in a cluster in accordance with the present invention. For illustration purpose, the table T contains 7 records, r1, r2, r3, . . . , r7. Each record has a plurality of attributes (column) among which attribute a is chosen as the primary key and attribute b is chosen as the secondary key.

A key is an attribute whose value can uniquely identify a record in the table T. A primary key is a key chosen to be used as the primary means to identify and search for a record in the table T. Each record in the table T can have one and only one primary key. In a cluster database, the primary key is also used to determine the distribution of the records among the storage nodes. Indices and/or search methods can be created to facilitate efficient search based on the primary key. A secondary key is an alternative key that can also be used to look up a unique record in the table T. The search based on a secondary key is usually less efficient than the search based on the primary key because the physical layout of the table T depends largely on the primary key.

With reference to FIG. 1, hash function h1( ) is created for attribute a and b, respectively. Hash function h1( ) maps the domain of the attribute to the set {0, 1, 2, 3, . . . , N-1}, where N is the number of storage nodes in the cluster. In the embodiment, N is chosen to be 3. Any hash functions that are uniform and random can be candidate for hash function h1( ). In this embodiment, hash function h1(a)=a mod N, where N=3.

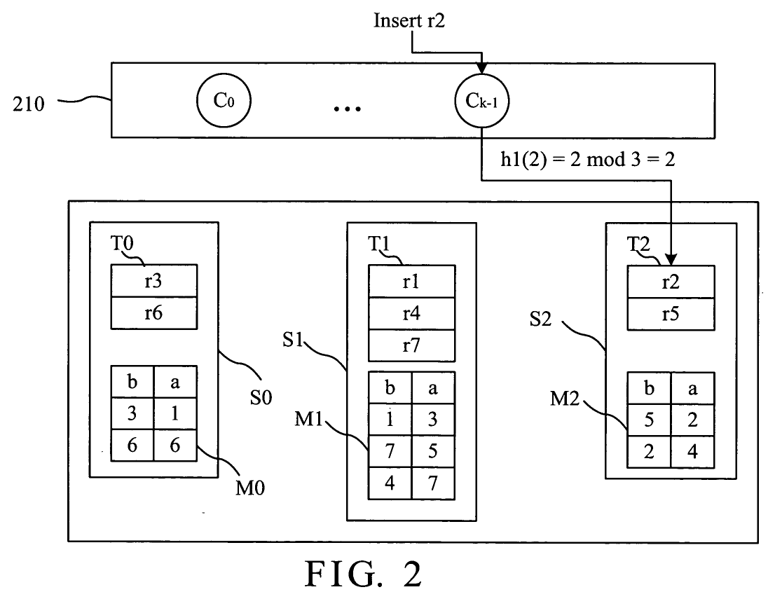

FIG. 2 is a schematic view of a peer-to-peer based secondary key search system in accordance with the present invention. In the search system, a cluster comprises a search term input means 210 having k server nodes, denoted by C₀ to Cₖ₋₁, respectively, and a plurality of storage nodes Si. In this embodiment, there are three storage nodes S0, S1 and S2 for illustrative purpose only.

Each storage node Si has a node number i and stores a plurality of records. Each storage node Si further comprises a mapping table Mi for mapping a secondary key to a corresponding primary key.

The search term input means 210 is coupled to the plurality of storage nodes Si for retrieving a record on a storage node Si. The search term input means 210 calculates a first node number based on a hash function of the secondary key, queries the first storage node with the secondary key for retrieving a corresponding primary key, calculates a second node number based on the hash function of the primary key, and then queries the second storage node with the primary key for retrieving a corresponding record.

As shown in the FIG. 2, a server node takes and processes request from clients (not shown) and returns with corresponding results. A storage node Si is a node that actually stores a fraction of the database records. The server nodes and storage nodes can co-locate, not necessary to be located on separate machines.

Each storage node Si maintains a local lookup table Ti that stores a subset of the records of table T, that is T0UT1UT2=T, where U represents the union operation. A record r is stored in storage node Si if the hash function h1( ) on the primary key of r maps it to i. That is: r belong to Ti if and only if h1(primary key of r)=i.

This is a well-known technique called hash partition that has been widely used in parallel database. With the hash partition, search based on the primary key can be efficiently done. To look up a record with a given primary key value A, the search system only needs to search on storage node h1(A), instead of all storage nodes.

The purpose of the invention is to facilitate efficient search based on secondary key. For this purpose, a mapping table Mi is created and maintained in each storage node Si. The mapping table Mi stores the (b,a) value pair for each record whose secondary key value is hashed to node Si. That is, for any record r of table T, (r.b, r.a) belongs to Mi if and only if h1(r.g)=i.

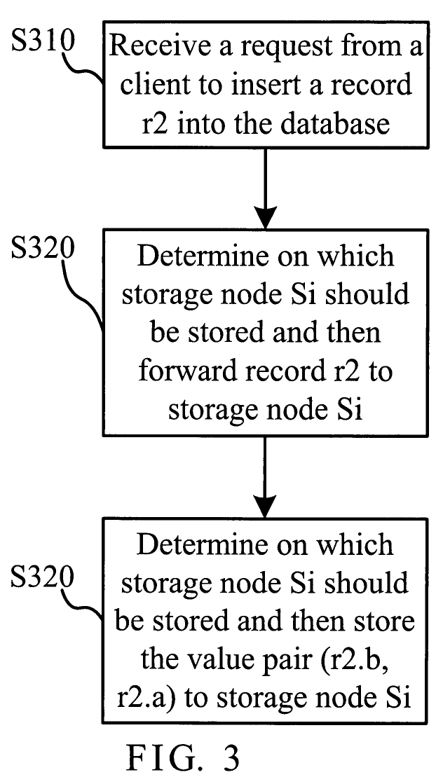

FIG. 3 is a flowchart of inserting a record into the database cluster in accordance with the present invention. In step S310, the search term input means 210 receives a request from a client to insert a record r2 into the database. In the FIG. 2, the search term input means 210 can be a server node Cₖ₋₁.

In step S320, the search term input means 210 applies hash function h1( ) to the primary key value of record r2 to determine on which storage node Si should be stored. Based on the hash function h1( ), this yield h1(r2.a)=h1(2)=2 mod 3=2, i.e., r2 should be stored on storage node S2. The search term input means 210 then forwards record r2 to storage node S2 and store the record r2 in the local lookup table T2.

In step S330, the search term input means 210 applies hash function h1( ) to the secondary key value of record r2 to determine on which storage node Si the (r2.b, r2.a) value pair should be stored. Based on the hash function h1( ), this yield h1(r2.b)=h1(5)=5 mod 3=2. Consequently, the value pair (r2.b, r2.a)=(5,2) is stored in the mapping table M2 on storage node S2.

To search for a record based on the primary key, it can simply follow the step S320 aforementioned to locate the storage node Si in which the record is stored.

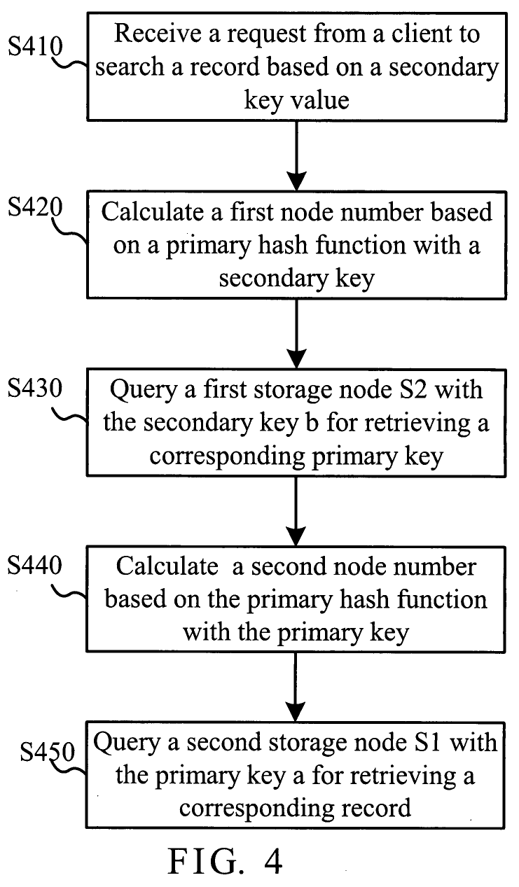

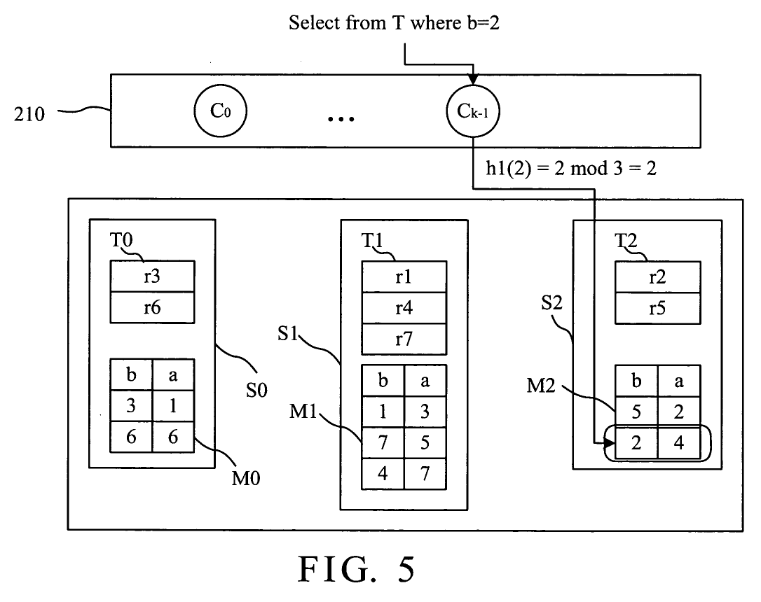

FIG. 4 is a flowchart for performing a secondary key-based record search in accordance with the present invention. FIG. 5 is a schematic view for performing a secondary key-based record search in accordance with the present invention. Please refer to FIG. 4 and FIG. 5, in step S410, the search term input means 210 receives a request from a client to look up a record based on a given secondary key value b. In this example, we have b=2. In FIG. 5, the search term input means 210 can be a server node Cₖ₋₁.

In step S420, the search term input means 210 calculates a first node number based on a hash function with a secondary key. The server node Cₖ₋₁, applies hash function h1( ) to the given secondary key value b=2 to calculate which storage node it should contact to get more information. This yield h1(b)=h1(2)=2 mod 3=2. Consequently, the server node Cₖ₋₁ forwards the parameter b to storage node S2.

In step S430, the search term input means 210 queries a first storage node S2 corresponding to the first node number with the secondary key value b=2 for retrieving a corresponding primary key. The storage node S2, upon receiving the parameter b=2, looks up its local mapping table M2 for an entry (b,a) whose b column matches 2. In this example, the secondary entry (2,4) is found to be the match. Consequently, the value of the corresponding primary key value (secondary column a=4) is returned to the requesting server node Cₖ₋₁.

In step S440, the search term input means 210 calculating a second node number based on the hash function with the primary key. Upon receiving the primary key a=4 from the storage node S2, the search term input means 210 then applies the hash function h1( ) to calculate a second node number based on the hash function h1( ) with the primary key value a=4. This yield h1(a)=h1(4)=4 mod 3=1. Consequently, the storage node S1 actually stores the record.

In step S450, the search term input means 210 queries a second storage node S1 corresponding to the second node number with the primary key value a=4 for retrieving a corresponding record. The storage node S1, upon receiving the primary key value a=4, looks up its own local table T1 for a match. In this example, the first record r4 in the table T1 s found to be the match because the r4.a=4. Consequently, record r4 is returned to the search term input means 210, which in turn returns the record r4 to the client as the result.

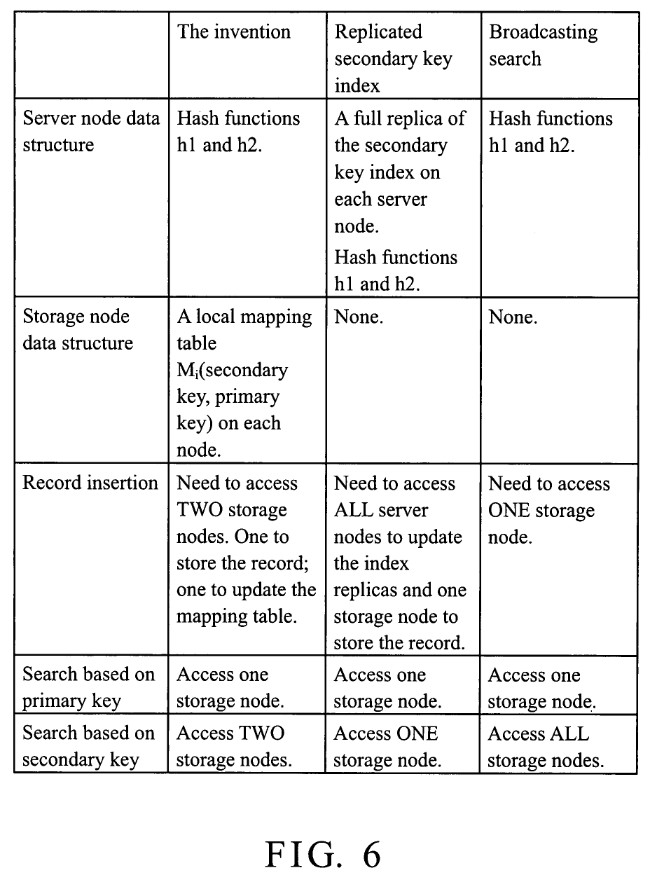

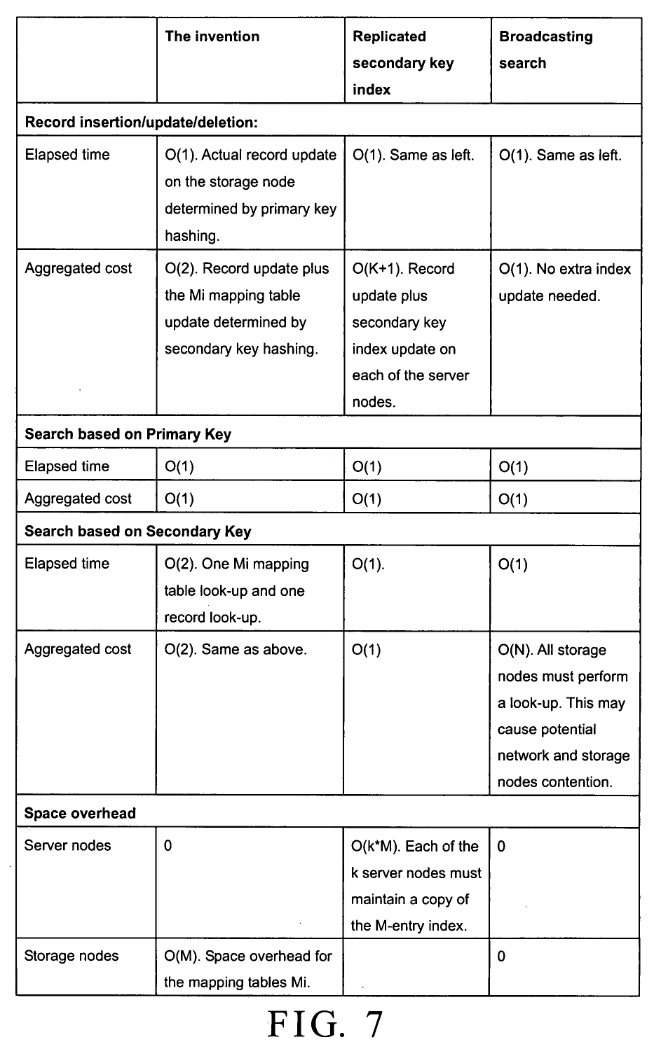

FIG. 6 and FIG. 7 are schematic views for structural and operation difference between Replicated Secondary Key Index, Broadcasting Search, and the invention. As shown in FIG. 7, there are K server nodes and N storage nodes in the cluster, and M is the total number of records in the table. As shown, aggregated cost of the invention is almost same with the Replicated Secondary Key Index, but the space overhead of the invention is much less than that of Replicated Secondary Key Index. The space overhead of the invention is almost same with the space overhead of Broadcasting Search and the aggregated cost of the invention is much less than the aggregated cost of Broadcasting Search.

In view of the foregoing, it is known that the invention has much better cost balance among record insertion, secondary key-based search, and the supporting data structures than the prior art. As shown in FIG. 6 and FIG. 7, the invention depends on the distribution of the mapping table Mi among the storage nodes and uses them to redirect the requests (on secondary key) to the target storage node. This peer-to-peer and redirect-based technology not only provides an efficient secondary key-based search method but also reduces the bandwidth among the search term input means 210 and the plurality of storage nodes Si. It involves only two storage nodes access and two round-trip messages between the search term input means 210 and the plurality of storage nodes Si.

Although the present invention has been explained in relation to its preferred embodiments, it is to be understood that many other possible modifications and variations can be made without departing from the spirit and scope of the invention as hereinafter claimed.

1. A peer-to-peer based secondary key search method for cluster database, the cluster database having a plurality of storage nodes and each storage node having a node number and storing a plurality of records, the method comprising the steps of:
(A) calculating a first node number based on a hash function of a secondary key;
(B) querying a first storage node corresponding to the first node number with the secondary key for retrieving a corresponding primary key;
(C) calculating a second node number based on the hash function of the primary key; and
(D) querying a second storage node corresponding to the second node number with the primary key for retrieving a corresponding record.

2. The peer-to-peer based secondary key search method as claimed in claim 1, wherein each storage node further comprises a mapping table for mapping a secondary key to a corresponding primary key.

3. The peer-to-peer based secondary key search method as claimed in claim 2, wherein the first storage node retrieves a corresponding primary key by the mapping table based on a secondary key.

4. The peer-to-peer based secondary key search method as claimed in claim 1, wherein the hash function is employed to perform a module of the input key.

5. A peer-to-peer based secondary key search system, comprising:
a plurality of storage nodes, each storage node having a node number and storing a plurality of records; and
a search term input means, coupled to the plurality of storage nodes, for retrieving a record at a storage node;
wherein the search term input means calculates a first node number based on a hash function of a secondary key, queries a first storage node corresponding to the first node number with the secondary key for retrieving a corresponding primary key, calculates a second node number based on the hash function of the primary key, and then queries a second storage node corresponding to the second node number with the primary key for retrieving a corresponding record.

6. The peer-to-peer based secondary key search system as claimed in claim 5, wherein each storage node further comprises a mapping table for mapping a secondary key to a corresponding primary key.

7. The peer-to-peer based secondary key search system as claimed in claim 6, wherein the first storage node retrieves a corresponding primary key by the mapping table based on a secondary key.

8. The peer-to-peer based secondary key search method as claimed in claim 6, wherein the hash function is employed to perform a module of the input key.
